(19) United States
(12) Patent Application Publication
(10) Pub. No.: US 2009/0107195 A1
(43) Pub. Date: Apr. 30, 2009

(54) Accessory for existing locks to prevent bump lock picking

(76) Inventor: Steven W. Gallian, Wilmington, NC (US)

Correspondence Address: Michael E. Mauney;Attorney at Law, P.O. Box 10266, Southport, NC, 28461, US

(21) Appl. No.: 11/981,074

(22) Filed: Oct. 30, 2007

(51) Int. Cl. E05B 27/04

(52) U.S. Cl. 70/493

(57) ABSTRACT

A modified pin to be used in an existing tumbler and pin lock to prevent the lock from unauthorized operation by a lock-picking technique known as “bumping.” A modified replacement pin is provided for an existing pin and tumbler lock. This modified replacement pin fits within the rotatable plug in the pin and tumbler lock. It replaces one of the longer pins of an existing pin set. The existing pin is cylindrical in shape. To modify the pin, a symmetrical notch is cut in proximity to one end of the pin. This notch causes the modified pin to catch on the plug during an attempted unauthorized opening by bumping the lock. Because the notch catches on the plug, it prevents the plug from turning. This effect is momentary but is enough to allow remaining pins in the pin and tumbler lock to fall into place to prevent the plug from turning and unauthorized operation of the lock.

### FIELD OF THE INVENTION

This invention relates to key operated locks and, more specifically, to cylinder locks using a pin arrangement. More specifically, this invention relates to a modified pin to fit within an existing lock to prevent unauthorized operation of the lock by a method of lock picking known as “bumping” or “bumping a lock.”

### BACKGROUND OF THE INVENTION

A cylinder lock usually includes a lock body which defines a bore. This bore has a corresponding cylinder plug to rotatably fit within the bore and to rotate therein. The cylinder plug has a key slot which defines a space for a key to be inserted and removed from the plug that fits within the bore within the lock body. In both the lock body and the plug, there are a plurality of pin bores that correspond with each other. Located within each of the corresponding pin bores there are at least two pins, a lock body pin and a plug pin. When there is no correct key inserted in the lock, the pins block rotation of the plug within the bore, hence block the operation of the lock and it is impossible to unlock the lock on the door. When the correct key is placed within the key slot in the plug, the key forces the plug pins to move in accordance with a particular pattern cut in the key. If the pattern matches the plug pin sizes, each plug pin aligns with the outer circumference of the cylinder plug. This means that the margin between each lock body pin and the corresponding plug pins are precisely aligned with the outer surface of the plug. This means that the pins no longer block rotation of the plug, allowing the plug to be rotated by the key, which also operates the locking bar which inserts into a slot into a door, safe wall, etc. It has long been understood that a skilled lock picker uses lock picks to individually manipulate the plug pins to the unlocked position. Typically, a lock picker will place the plug body under a slight rotational torque. The lock picker will then use the lock picks to try to align the plug pins with the circumference of the plug body. Typically, once a plug pin is aligned it will allow a slight movement of the cylinder plug, which will then have the effect of holding the plug pin in the proper unlocking position. Successively each plug pin of the plurality of plug pins may be moved into the unlocked position using the lock pick tools until all plug pins are in alignment and the plug will rotate to unlock the door. Thus, the lock is picked. A variety of expedients have been proposed to make a lock less susceptible to picking. The problem with the prior art is that the harder these expedients make a lock to pick, the more likely it makes the lock subject to jamming or not operable by a properly designed key. A lock that can't be opened with a correct key is as much a problem as a lock which can be opened by a lock picker. Moreover, most of the prior art expedients that propose a pickproof lock add substantial expense to manufacturing because these expedients require precise tolerances, precisely machined parts, and require a redesign of the lock mechanism.

One example of an attempt to pickproof a lock is seen in R. P. Croussore, U.S. Pat. No. 2,283,489. Notches are cut in either the lock body pin or in the plug pin or both. These notches cause the pin to catch as the lock is being picked, making it impossible to properly align either the lock body pin or the plug pin with the outer surface of the plug, which is required for circular movement of the plug. Almozino, U.S. Pat. No. 7,086,259, discloses outer and inner pins which again have recesses or slots to engage on the edge of the lock body tending to prevent a picking of the lock. A similar design is seen in Mendelsohn, U.S. Pat. No. 2,629,249. Here, a variety of slots cut in both the lock body and within the plug have matching helical slots cut in the pins, and the purpose of the slots cut in both the lock body, the plug, and the pins is to prevent manipulation of the pins into an unlocking position by use of picks. Widen, U.S. Pat. No. 4,577,479, discloses pins with slots cut in the pins as well as matching slots cut in either the lock body or the plug. The slots tend to catch in the corresponding slots cut in either the lock body or plug enhancing the difficulty of the picking process.

Each of these locks described above makes it more difficult for a skilled lock picker to pick the lock. However, each of these locks has a drawback of requiring precisely engineered pins, plugs, and lock bodies so that the lock will operate with a key. Duplicate keys which do not exactly match the appropriate key may not operate the lock. Also, as the key becomes worn, notched, or otherwise damaged, the precise tolerances required for operation of the lock, may make it difficult or impossible to operate the lock with the correct key. And for each of the above patents the locking mechanism of the lock body, plug, and pins are not useable in an existing standard lock not so designed.

Around 2003 a technique to open a lock called “lock bumping” received publicity. It was the subject of a Dutch television show in 2005. By 2006, papers were being published both at security conferences and generally available through the Internet describing both the security problem presented by lock bumping and describing the technique itself. The plurality of pins in the lock body and in the plug are sometimes referred to as the pin stack. The plug pin touches the key when it is inserted and the lock body pin has a spring which keeps it in contact with the plug pin, so when the proper key is inserted, the plug pins all align with the circumference of the plug which allows the cylinder plug to be turned. If the pins are not aligned with the circumference of the plug, then one or more of the pins will prevent the cylinder plug from being turned. To bump a lock, a specially designed bump key is placed in the key slot. Then, it is pulled one notch out along the key slot. Bumping or driving the key inward forces it deeper into the key slot. Specially designed teeth on the bump key force all of the pins in the lock upward. The specially designed bump key forces the plug pin upward to transmit force to the lock body pin. The lock body pin is held in place by a spring. Necessarily, the springs are elastic and allow movement when there is a bump applied to the key. Consequently, there is a split second provided by the bump where the lock body pin separates from the plug pin. The movement of the lock body pin lags behind the movement of the plug pin, meaning there is a short period of time where the plug pin is retracted within the surface of the plug pin slots within the plug, while the lock body pins are still suspended above the surface of the plug, albeit they are moving downwardly toward the plug pin because of the spring mounted within the lock body. However, if a rotational force is continuously applied on the cylinder plug during the bumping, it is enough, during this split second, to cause the plug to rotate allowing circular movement of the plug to unlock the lock. The separation between the plug pin and the lock body pin, albeit only for a split second, allows the cylinder plug to be rotated to pick the lock.

One way of avoiding a lock that is easily bumpable is to have restricted access to key blanks which can be turned into bump keys. However, many residential locks use the same basic key blank. Moreover, key blanks are widely available at hardware stores or other places that duplicate keys. Common brands of locks, especially locks within a set price range, will use the same key blanks by the lock manufacturers. Because certain lock brands are widespread, especially in more inexpensive or residential constructions, two or three bump keys will fit most residential locks. Electronic locks, magnetic locks, and combination locks are ordinarily not vulnerable to bumping. Some companies use side bars on the pins which will prevent bumping. One reason bumping presents a particular problem is that a bump key can be easily made from a key blank following instructions that are widely available on the Internet. For example, there is an instructional video available through Google® video which demonstrates how to use a simple file and a key blank to make a specially designed bump key. Because no exotic lock picking tool set is required, because the bump key is largely indistinguishable from other keys, and because no special skill is required to actually use a bump key to unlock a lock, it makes it easy for unskilled thieves to unlock locks that are widely used in residential settings and in some commercial settings. Homeowners are faced with the prospect of thieves being able to walk up to their residential lock, take a bump key, place it in the lock, bump the key, unlock the house and walk in. It has always been possible that a skilled thief using lock picks could pick the lock. This skill was beyond the capacity of most common thieves. Consequently, it would be an advance in the art to take an existing lock and, through simple modifications to the existing lock components to bump proof the lock.

### DETAILED DESCRIPTION OF THE DRAWINGS

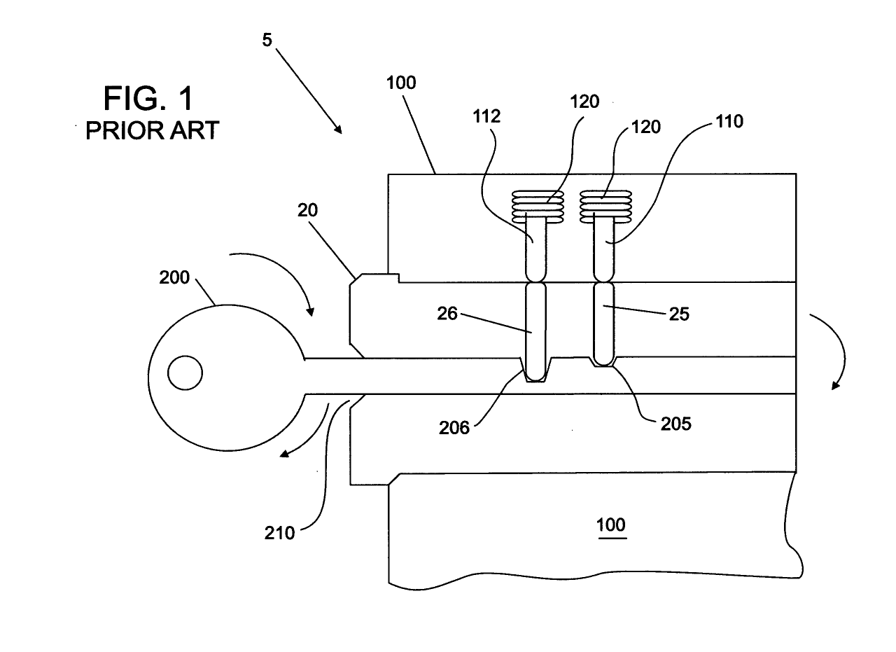

FIG. 1 shows a simplified cut-a-way view of a prior art pin and tumbler lock (5). There is a lock body (100). In the lock body (100) there is a circular bore filled with the plug (20). The plug (20) is mounted for rotational movement in a clockwise direction as shown by the arrows. A key (200) fits within the key slot (210) within the plug (20). Within the lock body (100) are two lock body pins (110) (112). These are biased toward the plug (20) by lock body springs (120). Positioned within the plug (20) are plug pins (25) and (26) which are oriented to precisely align with the matching lock body pins (110) (112). A standard pin and tumble lock will need five to seven pin sets. The key (200) has a notch (205) with a depth to match the plug pin (25). The key (200) has a second key notch (206) to match the plug pin (26). When the key (200) is inserted in the key slot (210) the notches (206) and (205) will allow the plug pins (26) and (25) to line up precisely along the outer circumference of the circular plug (200). If, for example, the key notch (206) was not cut deeply enough, then the plug pin (26) would extend upwardly into the lock body (100) blocking any rotational movement of the plug (20). Correspondingly, if the key notch (205) was cut too deeply, it would allow the plug pin (110) to extend into the plug (20) along the plug pin bore cut for the plug pin (25)—again blocking rotation of the plug (20). Consequently, a correct key will have the key notches cut at the correct heights to match the plug pins (25) and (26) to allow them to align with the circumference of the plug (20) to allow free rotation of the plug (20) to unlock the lock.

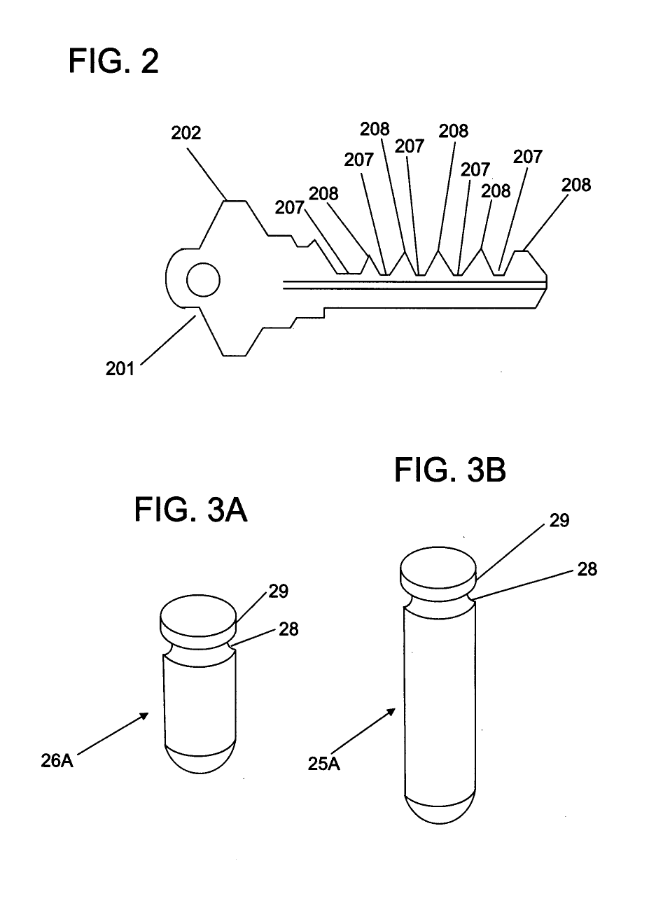

FIG. 2 shows a bump key (201) necessary to bump for a common type of key design. One will note immediately that there are five key pin notches (207) cut in the bump key (201). Each bump key notch (207) is cut as deeply as a key notch could be cut for this particular type of key. Differently designed keys are made for differently designed locks. However, the design feature that each bump key (201) has in common is that for each lock body/plug pin set in the lock that is to be bumped, there has to be a corresponding bump key notch (207) cut to the deepest level for that particular brand or type of key for the lock. The bump key (201) is inserted into the lock. It is then withdrawn from the lock one notch so the plug pins are all extended downwardly to the deepest point on the key notch (207) with the first notch (207) that is in proximity to the key handle actually withdrawn from the lock. A slight turning pressure is placed on the key handle (202). The pressure on the key handle (202) is exerted in the direction that would be used to open the lock with a correct key. Then a small blunt instrument such as the handle of a screwdriver is used to rap the key handle (202) forcing the bump key (201) all the way into the lock while simultaneously exerting a slight turning pressure on the key handle (202). The ridges (208) on the bump key (201) between the bump key notches (207) force the plug pins upwardly, “bumping” the lock body pins upwardly. The lock body springs (120) (not shown) force the lock body pins downward while also the plug pins are forced downwardly by the action of gravity. However, the bumping of the lock will cause all the lock body pins to rise above the circumference of the plug. The plug pins may remain below the circumference of the plus but usually one or more plug pins will rise above the circumference of the plug. As they return to the resting position in the bump key notches (207), they will pass the circumference of the plug allowing the plug to be turned in the lock and allowing to be opened. Consequently, all that is required to “bump” a lock open is a correctly designed bump key (201). These keys can be purchased on the internet. One need only go to an internet search engine and enter the term “bump key” and a variety of sites will be displayed which offer professionally cut bump keys for most common lock types. If one has a correct bump key, one need only have some knowledge of the technique and a screw driver or the like and virtually all common pin/tumbler locks can be opened using the bump key to “bump the lock.”

FIGS. 3A and 3B show the current invention modified plug pins (26A) and (25A). In each pin there is a lip (29) which extends a predetermined distance from the lock body pin end of the plug pin (26A) and plug pin (25A). Beginning at the edge of the lip (29) that is distal from the point of contact with the lock body pin, there is an indentation or pin notch (28) cut around the circumference of the plug pins (25A) and (26A). The pin notch (28) operates to prevent a lock from being bumped. The pin notch (28) is not an effective bar to a lock being picked by a skilled lock picker. In contrast to someone who is bumping a lock, a lock picker uses a tool to move each plug pin (25A) (26A) individually. A skilled lock picker is able to feel the motion of the plug pin (26A) and (25A) through the tool that is being used to manipulate the pins respectively. The pin notch (28) may operate to initially catch the plug pin (25A) and (26A), a skilled lock picker could take measures to avoid the pin notch (28) being caught on the edge of the circumference of the plug (20). A skilled lock picker using a set of lock picks relies on touch, feel, and experience to be able to pick a lock. This is in contrast to an unskilled individual attempting to open a lock by bumping it which is relying solely on momentum and gravity to move the plug pins (26A) and (25A) in position to allow the cylindrical plug to rotate within a lock body.

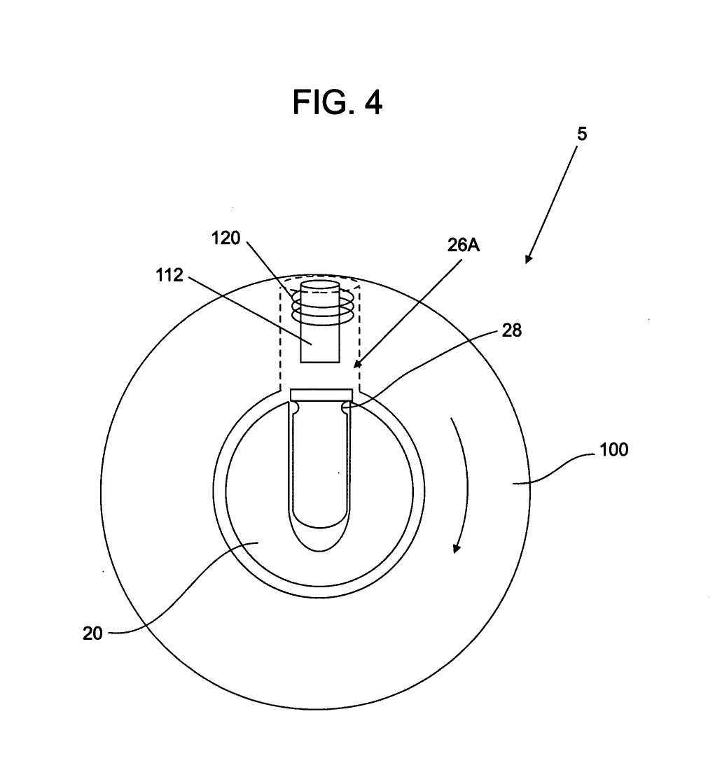

FIG. 4 shows how the pin notches (28) work to prevent bumping of a lock. When the bump is applied one or more plug pins bump above the circumference of the plug. The bumping of a lock depends on the force of gravity to pull the plug pins downwardly toward the circumference of the plug. Because there is a rotational pressure applied to the bump key (201), as each plug pin passes the edge of the circumference of the plug, it allows the plug to be rotated within the lock body thus unlocking the lock. FIG. 4 shows a cutaway, cross section, stylized version of a lock (5). Not seen in this view is the bump key (201). However, what is shown is the action of the plug pin (26A). Here, the lock has been bumped. There is a separation between the plug pin (26A) and the corresponding lock body pin (112). Because the plug (20) is under a slight clockwise torque and because the plug pin (26A) must movably fit within the plug pin bore in the plug (20), as the plug pin (26) is returning to a resting position against the bump key (201) (not shown), the pin notch (28) catches on the circumference of the plug (20) before the plug pin (26A) can return to a unlocked position within the plug pin bore in the cylindrical plug (20). Most locks have at least 5 to 7 matching pin sets of the plug pin and the lock body pin. If any one plug pin catches, then it prevents the cylindrical plug from turning within the lock and unlocking the lock. Because of the period of time of separation between the plug pin (26A) and the lock body pin (112) is only momentary as a lock is bumped, it is only necessary that the notch (28) catch and hold the plug pin (26A) in a locked position for a split second. As can be seen from the prior art, a simple notch cut in the side of a plug pin is not effective in preventing a lock from being picked. However, it is effective in preventing the lock from being bumped. This simple expedient has an additional advantage in that it does not require redesign of the lock. Whenever a lock is rekeyed, the pin set of the plug pins and lock body pins for a lock are replaced and matched with a new key. Consequently, all that is required to bump proof a lock is to replace the plug pins in the lock with bump proof plug pins as shown in FIG. 4 for plug pin (25A) and plug pin (26A) seen in FIG. 2. Indeed, it is not necessary even to rekey the lock so long as at least one appropriate replacement plug pin has an appropriate pin notch (28) cut around the circumference of the plug pin so that it will catch on the edge of the plug (20) for a brief moment of time to prevent the lock from being bumped.

The pin/tumbler lock type that uses a lock body and a cylindrical plug, is manufactured by a number of manufacturers. However, the market is dominated by several manufacturers and if one has a bump key to fit each of about seven prevalent lock types, this will be enough to open most doors using a pin/tumbler lock in a home or commercial setting. Each lock manufacturer, for example Kwikset® or Schlage®, has a certain number of pin sets in the pin/tumbler lock design. Specifically, there are five to seven pin sets corresponding to five to seven notches in the key. The pins are varying heights so that when the correct key is inserted, each plug pin will line up with the circumference of the circular plug. A bump key has slots cut at the bottom most point for a particular key blank for a particular lock type. The bump key is bumped. This forces the lock body pins upward above the circumference of the cylindrical plug. However, this does not necessarily mean that every one of the plug pins will be forced above the circumference of the plug. Consequently, the pin notch (28) on the plug pin must catch the edge of the circumference of the plug (20) which necessarily requires that the notched plug pin be bumped above the circumference of the plug (20). For most locks, only one particular plug pin is required to have the notch (28) to prevent bumping of the lock. However, this particular plug pin with a pin notch (28) must be one of the longest plug pin in a particular set of plug pins for a particular lock. Ordinarily, a slot will be cut in the key close to or near the depth of the cuts on a bump key for this particular longest plug pin. This assures when the key notches are not cut to the appropriate depth, the plug pin extends above the circumference of the plug to prevent the lock from being open without an appropriate notch cut in a key. Again, because it is necessary that not only that a plug pin with a pin notch (28) be bumped above the circumference of the circular plug but also that it be bumped far enough above the circumference of the plug that the pin notch (28) would be able to catch on the circumference of the plug to prevent the plug from circular motion to unlock the lock. This means that the pin notch (28) must be cut in the appropriate spot on the appropriate plug pin. It is impossible to be specific about dimensions for every potential lock type and plug pin that could be used for the many varieties of pin/tumbler locks that are on the market. It is required that when the plug pin rests on a ridge (208) extending between two of the notches (207) on the bump key (201) as seen in FIG. 2, that the pin notch (28) be at least at or above the circumference of the cylindrical plug.

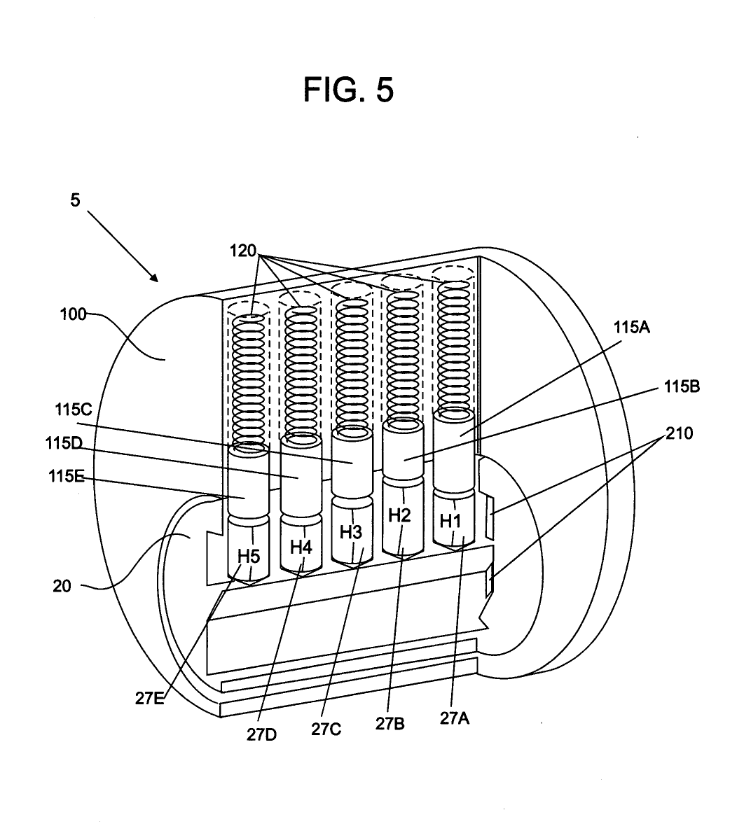

FIG. 5 shows the pin/tumbler lock (5) with five pins. The lock body pins are respectively labeled (115A), (115B), (115C), (115D), and (115E), whereas the plug pins are respectively labeled (27A), (27B), (27C), (27D), and (27E). The key slot (210) is on the right hand side of the drawing. However, here there is no key inserted in the key slot (210) in the cylinder plug (20). It will be immediately noted that each of the plug pins have a particular height. Here, plug pin (27B) has a height (H2) which is significantly larger that the heights of the other four plug pins (27A), (27C), (27D), and (27E). However, here the longest plug pin (27B) with a length of (H2) is in the slot beside the proximal plug pin to the key slot (210). For convenience, this will be referred to as the second plug pin. A particular type and brand of lock typically the longest plug pin will be in the same position. Here, the second position plug pin will also have a predetermined diameter with a minimum height and a maximum height based upon the dimensions of the particular lock type in which the plug pins are placed. Consequently, to bump proof the lock it is only necessary to replace the plug pin (27B) with a plug pin that has the pin notch (28) on the plug pin (27B). Again, depending on the particular type of lock for which the replacement plug pin with the pin notch (28) is designed, the location of the pin notch on the plug pin will be determined by the dimensions of the particular lock. This may vary from brands of locks or from one lock design to another but within a single brand and single lock design, ordinarily, the same replacement plug pin (27B) can be used in each lock of that particular brand and model. Consequently, if a locksmith wishes to bump proof a particular lock, he need only determine the lock brand and lock model and then replace the tallest plug pin with the bump proof plug pin having the pin notch (28).

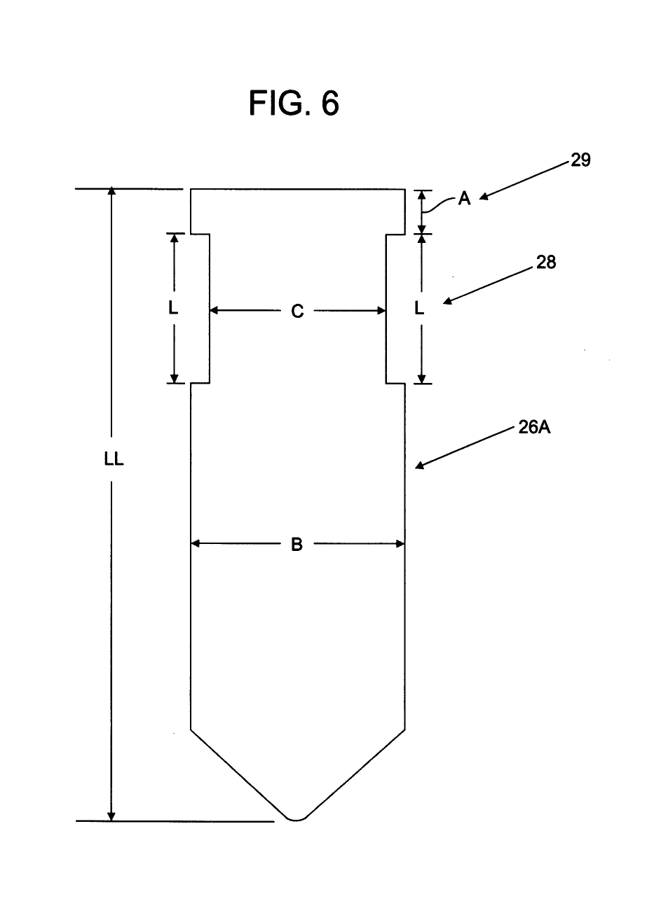

FIG. 6 shows an exemplar of an invention bump proof plug pin (26A). The plug pin (26A) is generally cylindrical with an overall length (LL) and a uniform diameter (B) except at the point where pin notches (28) are cut around the circumference of the plug pin (26A). Here, the reduced diameter (C) of the pin notches (28) is in a specified relationship to the diameter (B) of the plug pin (26A). Likewise, the lip (29) has a specified dimension (A) extending from the lock body pin end in plug pin (26A) to the beginning of the pin notch (28). In most standard locks, the plug pin diameter (B) is 0.115 inches. The pin notch diameter (C) is 0.075 inches. The lip (29) dimension (A) is 0.035 inches. The pin notch (28) length (L) is 0.100 inches. The overall length (LL) of the plug pin (26A) varies depending on the size of the tumbler and the lock manufacturer. The relationship among the dimensions has importance in terms of the functioning of the bump proof lock body pin (26A). If the dimension (A) is too large, then, even when bumped, the pin notch (28) will not extend above the circumference of the plug (20), hence will not catch on the plug (20) and hold the lock body pin (26A) momentarily in a locked position to prevent the lock from being bumped. Likewise, the pin notch (28) must be of sufficient depth on the circumference of the plug (20). It is believed the dimensions outlined above are appropriate for most locks manufactured in the United States which are subject to bumping, but it will be understood that a particular dimension is determined by the functioning of the lock for which the replacement bump proof plug pin (26A) is designed.

1. An accessory for a particular existing pin/tumbler design lock, having a lock body which defines a plug bore, a cylinder plug to rotatably fit within the plug bore, a plurality of lock body pin bores with lock body pins disposed in said lock body pin bores, a plurality of plug pin bores in said circular plug, arranged to correspond with the plurality of lock body pin bores, and a plug pin in each of said plurality of plug pin bores, comprising:
(a) at least one replacement plug pin to fit within one of said plug pin bores corresponding to at least one lock body pin whereby a first end surface of said at least one replacement plug pin is in proximity to a first end surface of said at least one lock body pin; and opposite from said first end surface of said at least one replacement plug pin, a second end surface of said at least one replacement plug pin proximal to a key slot in said cylinder plug;
(b) on said at least one replacement plug pin, a symmetrical notch extending around circumference of said at least one replacement plug pin defining a reduced cross section; and
(c) said symmetrical notch of said at least one replacement plug pin is cut in proximity to said first surface of said at least one replacement plug pin and at a predetermined distance from said first surface.

2. An accessory for a particular existing pin/tumbler design lock, having a lock body which defines a plug bore, a cylinder plug to rotatably fit within the plug bore, a plurality of lock body pin bores with lock body pins disposed in said lock body pin bores, a plurality of plug pin bores in said circular plug, arranged to correspond with the plurality of lock body pin bores, and a plug pin in each of said plurality of plug pin bores of claim 1, further comprising said symmetrical notch is cut at a predetermined depth on said at least one replacement plug pin whereby said defined reduced cross section is in a defined relationship to a full cross section of said at least one replacement plug pin.

3. An accessory for a particular existing pin/tumbler design lock, having a lock body which defines a plug bore, a cylinder plug to rotatably fit within the plug bore, a plurality of lock body pin bores with lock body pins disposed in said lock body pin bores, a plurality of plug pin bores in said circular plug, arranged to correspond with the plurality of lock body pin bores, and a plug pin in each of said plurality of plug pin bores of claim 2, wherein said symmetrical notch is cut on said at least one replacement plug pin of a predetermined length for a particular existing lock.

4. An accessory to prevent bumping to open a lock for a particular existing pin/tumbler design lock, having a lock body which defines a plug bore, a cylinder plug to rotatably fit within the plug bore, a plurality of lock body pin bores with lock body pins disposed in the bores, a plurality of plug pin bores in said cylinder plug arranged to correspond with the plurality of body pin bores, a plug pin in each of said plurality of plug pin bores, comprising at least one replacement plug pin to fit within plug pin bores, said replacement plug pin having an inwardly radially sloping shoulder defining a symmetric notch in said replacement plug pin whereby during an attempt to bump open an existing pin/tumbler lock design said radially sloping shoulder is cammed in an inward direction along the shear line of said lock body bore catching and holding said cylinder plug from rotating.

5. An accessory to prevent bumping to open a lock for a particular existing pin/tumbler design lock, having a lock body which defines a plug bore, a cylinder plug to rotatably fit within the plug bore, a plurality of lock body pin bores with lock body pins disposed in the bores, a plurality of plug pin bores in said cylinder plug arranged to correspond with the plurality of body pin bores, a plug pin in each of said plurality of plug pin bores of claim 4, wherein said defined symmetrical notch is at a predetermined depth in said at least one replacement plug pin whereby a first cross section of said one replacement plug pin taken at said symmetrical notch is in a defined relationship of a second cross section taken at a point other than said symmetrical notch on said at least one replacement plug pin.

6. An accessory to prevent bumping to open a lock for a particular existing pin/tumbler design lock, having a lock body which defines a plug bore, a cylinder plug to rotatably fit within the plug bore, a plurality of lock body pin bores with lock body pins disposed in the bores, a plurality of plug pin bores in said cylinder plug arranged to correspond with the plurality of body pin bores, a plug pin in each of said plurality of plug pin bores of claim 5 wherein said radially sloping shoulder is is cut on at least one replacement plug pin of a predetermined length, said predetermined length defined for use in a particular existing lock.
